(19) United States
(12) Patent Application Publication
(10) Pub. No.: US 2018/0063045 A1
(43) Pub. Date: Mar. 1, 2018

(54) MITIGATION OF ONLINE MEETING INVITATION FAILURE

(71) Applicant: MICROSOFT TECHNOLOGY LICENSING, LLC, Redmond, WA (US)

(72) Inventors: Stephen H. Houchen, Redmond, WA (US); Anthony C. Romano, Redmond, WA (US); Ilya Bukshteyn, Redmond, WA (US)

(73) Assignee: MICROSOFT TECHNOLOGY LICENSING, LLC, Redmond, WA (US)

(21) Appl. No.: 15/367,727

(22) Filed: Dec. 2, 2016

Related U.S. Application Data
(60) Provisional application No. 62/380,478, filed on Aug. 28, 2016.

(51) Int. Cl. H04L 12/58; H04L 29/12; H04L 29/06

(52) U.S. Cl. CPC H04L 51/046; H04L 65/1006; H04L 61/3085; H04L 51/22

(57) ABSTRACT

An online meeting invitation may fail for a variety of reasons, and a meeting organizer or participant may wish to provide an alternative approach to transmit an invitation to the invitee before or during the meeting. Accordingly, embodiments are directed to mitigation of a failure of an online meeting invitation. A meeting invitation may be transmitted for presentation, to an invitee. In response to receipt of a failure notification to reach the invitee, the failure may be mitigated by identifying an email address associated with the meeting invitation and initiating one or more function calls to a communication service to have an invitation email generated and transmitted to the identified email address, where the invitation email includes the meeting invitation in a body of the imitation email. Alternatively, just the meeting invitation may be automatically forwarded to the email address upon identification of the email address.

### CROSS-REFERENCE TO RELATED APPLICATION

This application claims benefit under 35 U.S.C. § 119(e) of U.S. Provisional Application No. 62/380,478 filed on Aug. 28, 2016. The U.S. Provisional Application is herein incorporated by reference in its entirety.

### BACKGROUND

An invitation to an online meeting may fall for a variety of reasons. For example, an invitee may not be available to view an invitation or an invitation may expire before the invitee has a chance to view the invitation. Additionally, the invitee may be available but otherwise engaged with another online personality that is unable to review the invitation or the invitee may be logged in with an account that is unable to receive the invitation. As a result, a meeting organizer or participant may wish to provide an alternative approach to transmit an invitation to the invitee before or during an online meeting.

### SUMMARY

This seminary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to mitigating a failure of an online meeting invitation. In some embodiments, a productivity service may transmit a meeting invitation to an invitee and initiate operations to mitigate an invitation failure upon receiving a failure notification to reach the invitee. For example, the productivity service may identify an email address associated with the meeting invitation, initiate one or more function calls to a communication service to have an invitation email with the meeting invitation in a body of the invitation email generated and transmitted to the identified email address. Alternatively, the productivity service may forward just the meeting invitation upon identification of the email address. In other embodiments, these actions may be performed similarly fey a client, such as an application of the productivity service executing on a client device.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIGS. 1A-C include display diagrams illustrating example network environments where mitigation of a failure of an online meeting invitation may be implemented.

FIG. 2 includes a display diagram illustrating an example scheme to mitigate a failure of an online meeting invitation;

FIG. 3 includes a display diagram illustrating an example invitation email;

FIG. 4 is an example networked environment, arranged in accordance with at least some embodiments described herein;

FIG. 5 illustrates a general purpose computing device, which may be configured to mitigate a failure of an online meeting invitation, arranged in accordance with at least some embodiments, described herein;

FIG. 6 illustrates a logic-flow diagram for an example server-side process-to mitigate a failure of an online meeting imitation; and

FIG. 7 illustrates a logic flow diagram for an example client-side process to mitigate a failure of an online meeting invitation, arranged in accordance with at least some embodiments described herein.

### DETAILED DESCRIPTION

As briefly described above, embodiments are directed to mitigation of failures of online meeting invitations by a productivity service or a client associated with the productivity service. For example, a meeting invitation may be transmitted to an application associated with the productivity service for presentation to an invitee. The meeting invitation may be transmitted in response to detecting a selection by a meeting organizer or current invitee to add the invitee to a meeting associated with the meeting in invitation before or during the meeting. In response to receipt of a failure notification to reach the invitee, the failure may be mitigated by identifying an email address associated with the meeting invitation and initiating a function call or multiple function calls to a communication service to have an imitation email generated and transmitted to the identified email address. The invitation email may include the meeting invitation in a body of the email The function calls may be sent to the communication service through standard or custom application-programming interfaces (APIs). Standard or custom functions may be used to instruct the communication service to perform the tasks associated with mitigating the failure. In some examples, the failed meeting invitation may be transmitted using Session Initiation Protocol (SIP) and the email address for the invitee may be determined from the SIP address. In other examples, search(es) may be performed on local or remote address books.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with, other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that, are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example processes). The-computer-readable storage medium is a computer-readable memory device. The computer-readable storage medium can for example be implemented via one or more of a volatile computer memory, a non-volatile memory, a hard drive, a Hash drive, a floppy disk, or a compact disk, and comparable hardware media.

Throughout this specification, the term “platform” may be a combination of software and hardware components to mitigate a failure of an online meeting invitation. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

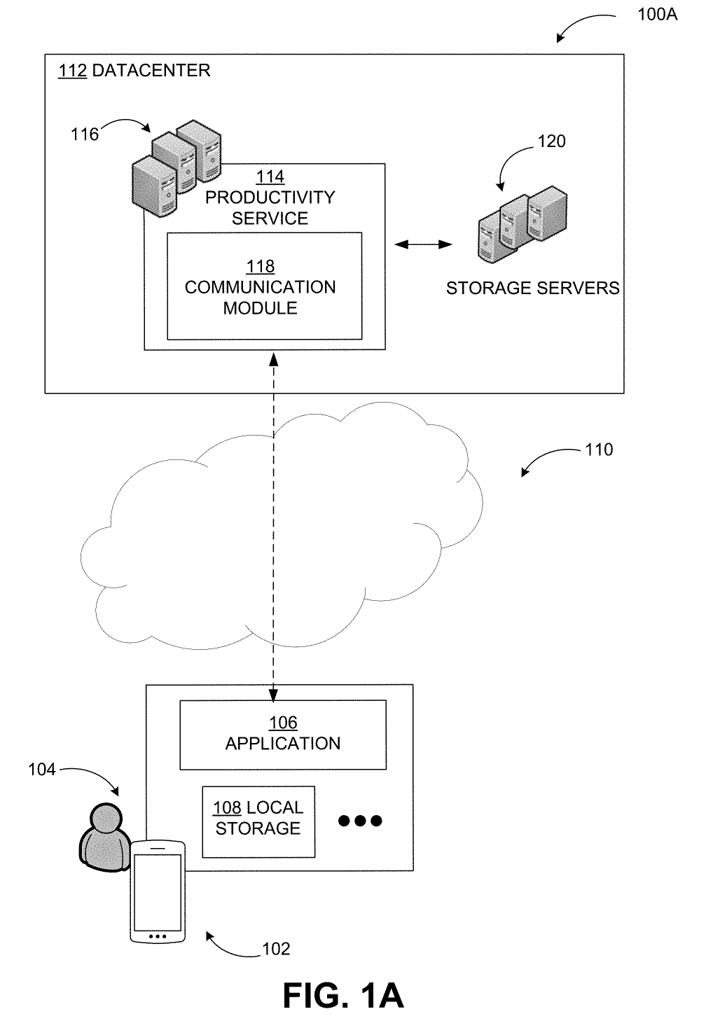

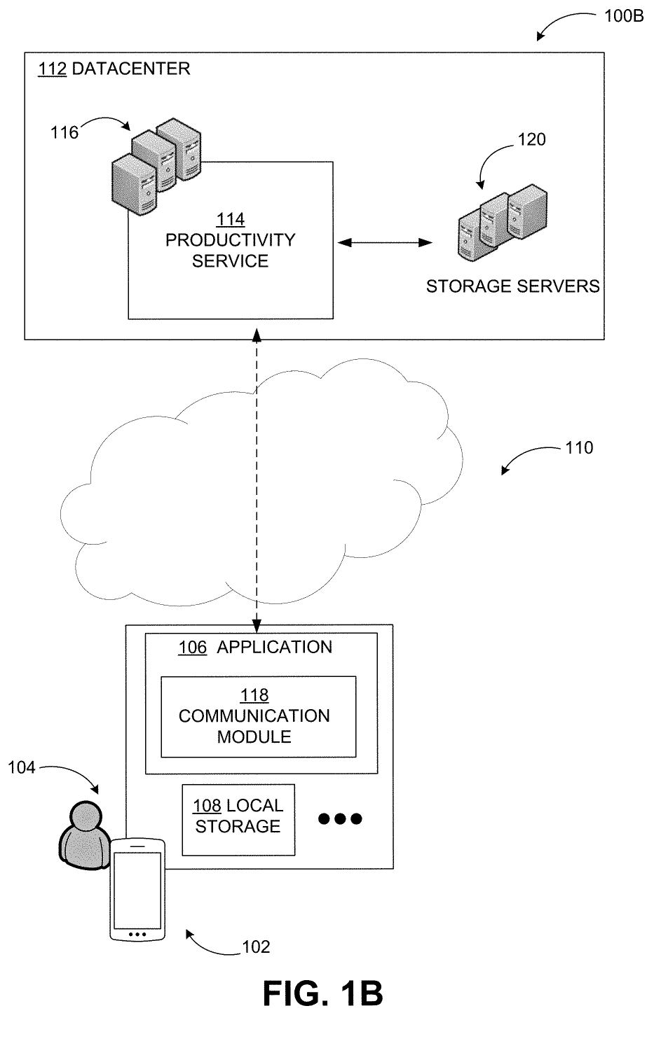

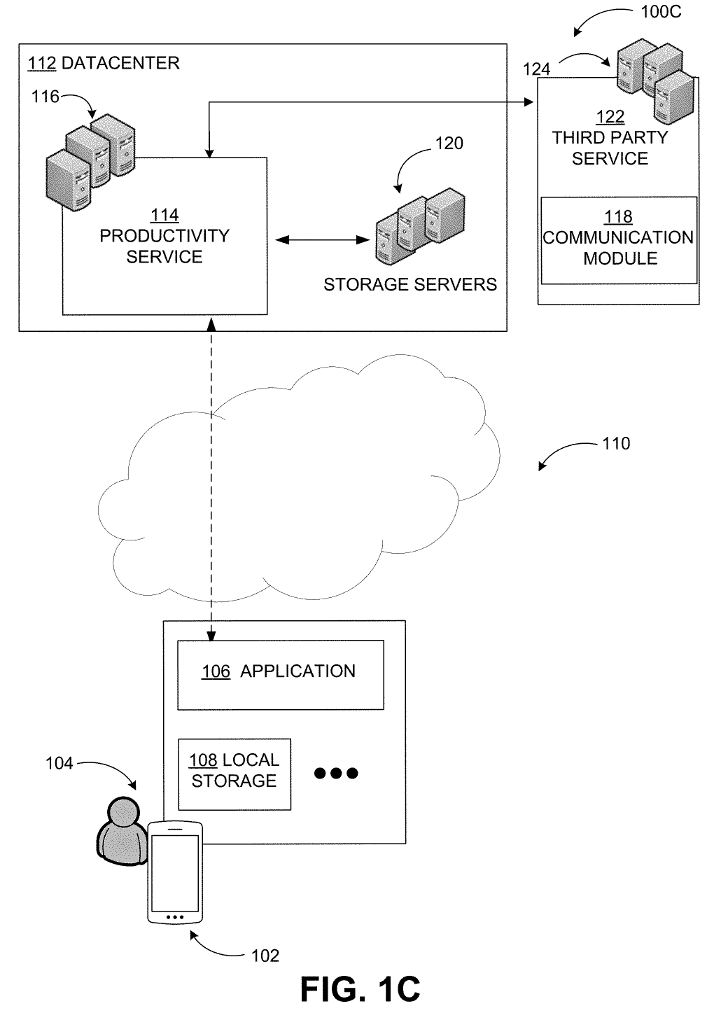

FIGS. 1A-C include display diagrams illustrating example network environments where mitigation of a failure of an online meeting may be implemented. As illustrated in diagrams 100A-C, an example system may include a datacenter 112 hosting a cloud-based productivity service 114 configured to enable users to create, edit, and/or share content among multiple devices and across a variety of platforms. The datacenter 112 may include one or more processing servers 116 configured to execute the productivity service 114, among other components. The datacenter 112 may also include one or more storage servers 120 configured to manage one or more data, stores comprising data associated with the productivity service 114. As described herein, the productivity service 114 may be implemented as software, hardware, or combinations thereof.

In some embodiments, the productivity service 114 may be configured to interoperate with various applications. For example, as illustrated in the diagrams 100A-C, a user 104 may execute a thin (e.g., a web browser) or a thick (e.g., a locally installed client application) version of an application 106 through a device 102 with which the productivity service 114 may be configured, to integrate and interoperate with over one or more networks, such as network 110. The application 106 may be an application hosted by the productivity service 114. The application 106 may be configured to store information, such as online meeting data, in local storage 108 of the device, or provide the information to the productivity service 114 for remote storage at the storage servers 120. The application 106 may be a communication application, a calendar application, a word-processing application, a notebook application, and/or a spreadsheet application among other examples. The device 102 may include a desktop computer, a laptop computer, a tablet computer, a vehicle mount computer, a smart phone, or a wearable computing device, among other similar devices. A communication interface may facilitate communication between the productivity service 114 and the application 106 over the network 110.

In one embodiment, as illustrated in diagram 100A, at least one of the processing servers 116 may be operable to execute a communication module 118 of the productivity service 114, where the communication module 118 may be integrated with the productivity service 114. In another embodiment, as illustrated in diagram 100B, the application 106 may be operable to execute the communication module 118, where the communication module 118 may be integrated with the application 106. In a further embodiment, as illustrated in diagram 100C, the communication module 118 may be a separate module associated with and/or executed by one or more processing servers 124 of a third party service 122 configured to serve multiple applications, such as the application 106 of the productivity service 114.

Some online meetings may be pre-scheduled and invitations to the online meetings may be distributed to invitees over email. The invitees may join the meeting at the appropriate time through the join information provided within the email. For example, the email may include a join link or dial-in phone numbers and passcodes. Other online meetings may be created in an ad-hoc fashion. A user may search for one or more other users to invite to the meeting, and upon inviting them the users may be presented with a notification (“toast”) at their endpoint, which they can tap/click to get into the meeting immediately. Regardless of whether a meeting is scheduled or ad-hoc, additional people may be added to any meeting after it has begun. Similar to how an ad-hoc meeting is stalled, a user can search for one or more people and invite them to the in-progress meeting. The invitees get a notification at their endpoint, and they may accept the notification to become part of the meeting.

In an example scenario, while a person is in a meeting, they may like to invite someone else into the meeting, such as the user 104. They may search and try to add the user 104 (the invitee) to the meeting, but the user 104 may not accept the notification. This may be for any number of reasons, for example; (1) the user 104 may not be online at the time; (2) the user's notification may have timed out before they noticed it; (3) the user 104 may be signed-in at another physical place, but is currently working on a device that does not have a SIP client; or (4) the address typed into the meeting device's search box may not a valid SIP address (e.g., it may actually be an email address like foo@gmail.com, or a well-formed SIP address that does not exist like nosuchuser@nosuchdomain.com). In such a scenario, the originating person typically does not have a fallback option, and the meeting invitation may fail.

In an example embodiment, the communication module 118 may be configured to mitigate such failures of online meeting invitations. The communication module 118 may transmit the meeting invitation to the application 106 for presentation to the user 104 (an invitee). For example, the communication module 118 may be configured to transmit the meeting invitation to the invitee in response to detecting a selection by a meeting organizer or current invitee to add the invitee to a meeting through a user experience of the application 106. This may occur before or during the meeting. In some examples, the application 106 may be configured to provide the selection to add the invitee to the meeting to the productivity service 114 through the communication interlace.

For a variety of reasons such as those discussed above, the application 106 may fail to receive and present the meeting imitation to the user 104. In one embodiment, the application 106 may be configured to generate a failure, notification, and provide the failure notification to the communication module 118. In another embodiment, the failure notification may be generated by the communication module 115 upon a failure to receive a confirmation of the meeting invitation. However, the communication module 118 may not attempt to mitigate a failure to deliver and render the meeting invitation at the application 106 if the user 104 transmits a rejection of the meeting invitation. In response to receipt of the failure notification, the communication module 118 may be configured to identify an email address associated with the meeting invitation. The email address may be identified by first looking up the invitee to whom the meeting invitation was transmitted in an address book by the SIP address. Or if that is unsuccessful, the email address may be identified by reinterpreting the SIP address as an email address. The email address may include a destination of the meeting invitation as such may be a component of the meeting invitation. In one embodiment, the communication module 118 may be configured, to initiate one or more function calls to a communication service, to have an invitation email generated and transmitted to the identified email address for presentation to the user 404 through a user experience of the application 106.

Some of the actions and/or processes described herein have been illustrated from the perspective of a server (for example, the processing servers 116 configured to execute the productivity service 114), however similar actions may be performed similarly by a client (for example, the application 106), among other entities.

As discussed, an invitation to an online meeting may fail for a variety of reasons, such as unavailability, lack of connectivity, lack, of features to receive and render, and/or similar ones. Therefore, a meeting organizer may wish to provide an alternative approach to transmit an invitation to the invitee before or during the meeting. Embodiments, as described herein, are directed to mitigation of such failures of online meeting invitations. Mitigation of meeting invitation failures may improve performance, reduce processing and network bandwidth usage, and improve user interaction.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with user communication through productivity services hosted across a variety of platforms and devices.

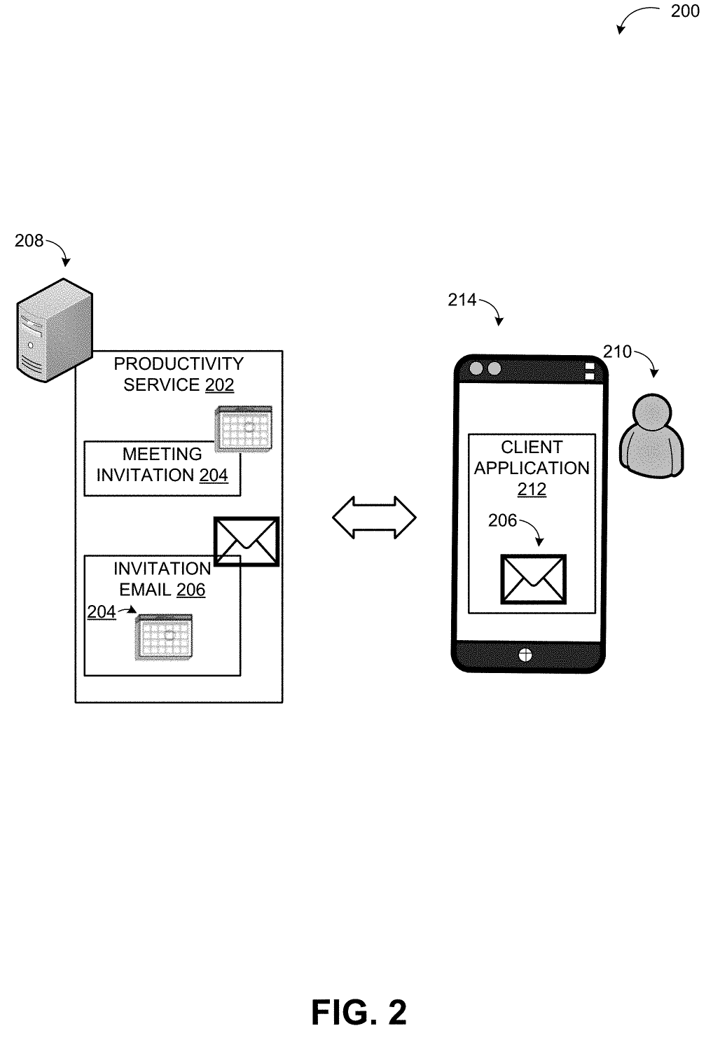

FIG. 2 includes a display diagram illustrating an example scheme to mitigate a failure of an online meeting invitation.

As shown in a diagram 200, a productivity service 202 executed on a physical server 208 may be configured to mitigate a failure of a meeting invitation 204. In an example scenario, the productivity service 202 may transmit the meeting invitation 204 to a client application 212 executing on a client device 214 for presentation to an invitee 210. For a variety of reasons such as unavailability, lack of connectivity, lack of features to receive and render, and/or similar ones, the client application 212 may fail to receive and present the meeting invitation 204 to the invitee 210. In such a scenario, the client application 212 may generate a failure notification and provide the failure notification to the productivity service 202. Alternatively, the failure notification may be generated by a component of the productivity service 202 upon a failure to receive a confirmation of the meeting invitation 204. The productivity service 202 may initiate operations to mitigate the failure of the meeting invitation 204 in response to receiving the failure notification to reach the invitee 210 from the client application 212. However, the productivity service 202 may not attempt to mitigate a failure to deliver and render the meeting invitation 204 at the client application 212 if the invitee transmits a rejection of the meeting invitation 204.

The productivity service may identify an email address associated with the meeting invitation 204. The email address may include a destination of the meeting invitation 204 as such may be a component of the meeting invitation 204. The meeting invitation 204 may either be forwarded to the identified email address or an invitation email 206 may be generated and the meeting un nation 204 may be inserted into the invitation entail 206 for transmission to the identified email address.

In an example scenario, the productivity service 202 may search an address book associated with the invitee to identify the email address. The address book may include contact information of a meeting organizer. If the productivity service 202 may locate an email address associated with the invitee 210 within the address book, the productivity service 202 may forward the meeting invitation 204 to the located email address or generate the invitation email 206 with the located email address. If the address book search returns no valid email address, but a well-formed address like user@example.com is fully typed, then the same address would be taken as an email address. For example, when the invite to sip:user@example.com fails, the meeting invitation may be forwarded by email to user@example.com. This may also be a useful technique if the invitee 210 is not federated with an organization with which meeting organizer is associated. Alternatively, the productivity service 202 may use an email address of the invitee 210 provided by the meeting organizer to initially generate the meeting invitation 204.

Furthermore, the invitation email 206 may also include a notification that describes attempts to contact the invitee 210 to deliver the meeting invitation 204 and failure(s) associated with the attempts. The notification may inform the invitee 210 of a history associated with the meeting invitation 204. In another example scenario, the invitation email 206 may include descriptive content (with or without the meeting invitation 204) that provides links(s) or other features to join the meeting online.

While a productivity service is used as an illustrative example herein, embodiments may be implemented in other service environments as well. For example, the productivity service may relay communications that include the meeting invitation 204 and/or the invitation email 206 from third party service providers, such as a calendar provider and/or an email provider, among others to the client application 212. Additionally, the actions and/or processes described herein have been illustrated from the perspective of a server (for example, the processing servers 1208 configured to execute the productivity service 202), however similar actions may be performed similarly by a client (for example, the client application 212), among other entities,

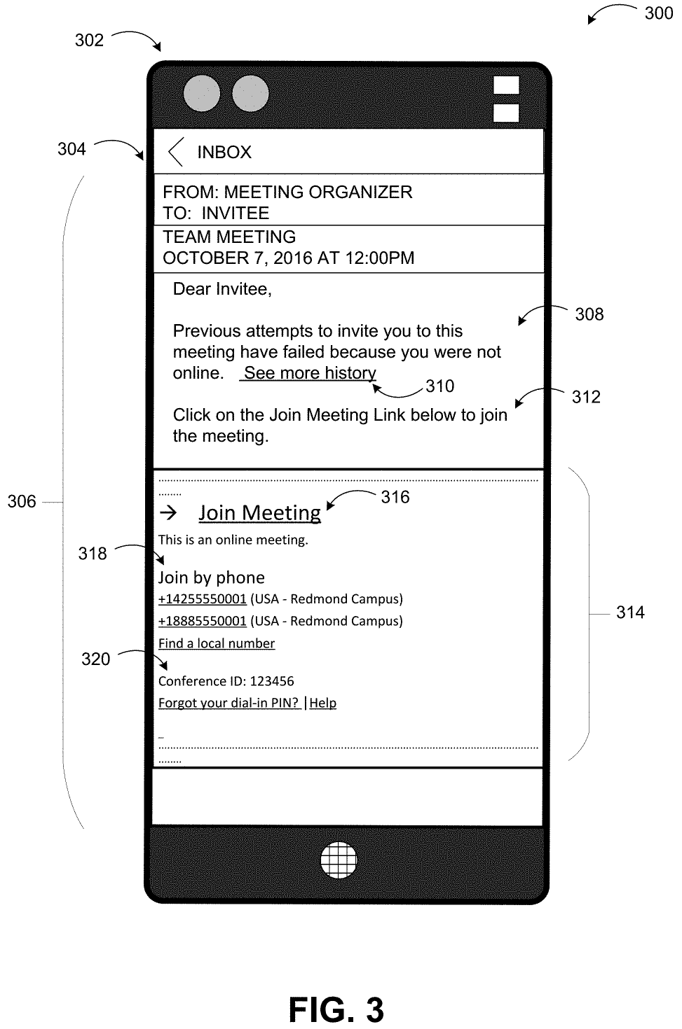

FIG. 3 includes a display diagram illustrating an example invitation email. As previously discussed, a productivity service may transmit a meeting invitation to an application associated, with the productivity service for presentation to an invitee, where the application may be executed on a client device 302 of the invitee. In response to receipt of a failure notification to reach the invitee, the productivity service may be configured to mitigate the failure by identifying an email address associated with the meeting invitation, generating an invitation email 306 that includes the meeting invitation 314, and transmitting the invitation email 306 to the email address for presentation to the invitee through a user experience 304 of the application, as shown in a diagram 300. Alternatively, just the meeting invitation may be forwarded to the email address upon identification for presentation to the invitee.

The invitation email 306 may also include a notification 308 that describes attempts to contact the invitee to deliver the meeting invitation and failure(s) associated with the attempts. The notification 308 may inform the invitee of a history associated with the meeting invitation through a selectable link 310, for example. The invitation email 306 may further include descriptive content with the meeting invitation 314 that provides join link(s) 316 to join the meeting online. Additional join features, such as options to join the meeting by phone 318, and any relevant passcodes 320 may also be provided within the meeting invitation 314. In some examples, the invitation email, may have a main instruction 312 directing the invitee to click on the join link(s) 316 to join the meeting.

The examples provided in FIG. 1 through FIG. 3 are illustrated with specific systems, services, applications, modules, and user experiences. Embodiments are not limited to environments according to these examples. Mitigation of a failure of an online meeting invitation may be implemented in environments employing fewer or additional systems, services, applications, modules, and user experiences. Furthermore, the example systems, services, applications, modules, and user experiences shown in FIG. 1 through FIG. 3 may be implemented in a similar manner with other values using the principles described herein.

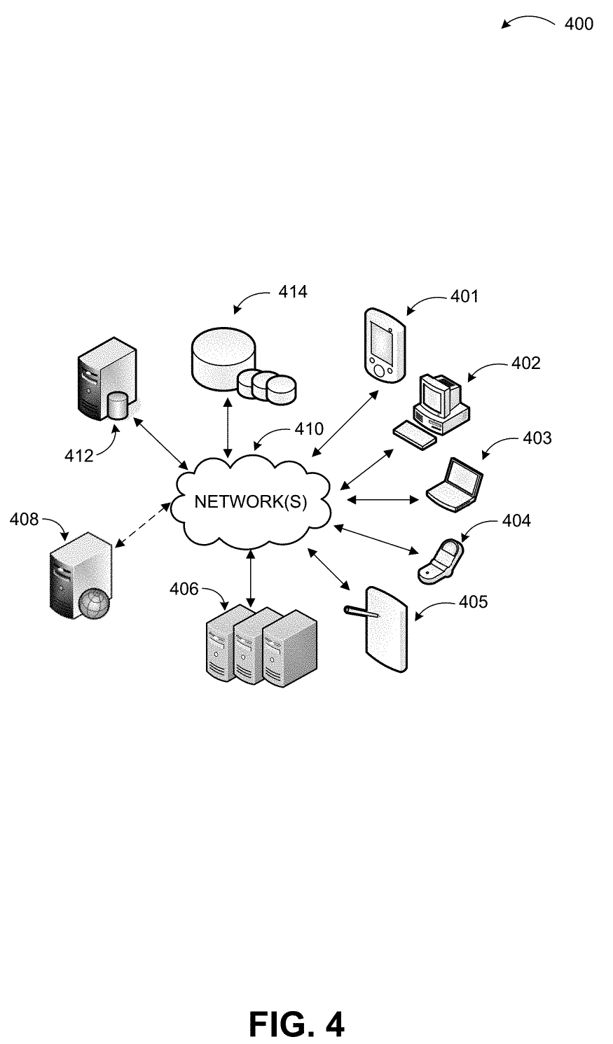

FIG. 4 is an example networked environment, arranged in accordance with at least some embodiments described herein. In addition to locally installed applications (for example, application 106), a communication module may also be employed in conjunction with hosted applications and services (for example, a productivity service 114) that may be implemented via software executed over one or more servers 406 or individual server 408, as illustrated in diagram 400. A hosted service or application may communicate with client applications on individual computing devices such as a handheld computer 401, a desktop computer 402, a laptop computer 403, a smart phone 404, a tablet computer (or slate), 404 (‘client devices’) through network(s) 410 and control a user interface presented to users.

Client devices 401-404 are used to access the functionality provided by the hosted service or application. One or more of the servers 406 or server 408 may be used to provide a variety of services as discussed above. Relevant data may be stored in one or more data stores (e.g. data store 414), which may be managed by any one of the server 406 or by database server 412.

Network(s) 410 may comprise any topology, of servers, clients, Internet service providers, and communication media. A system according to embodiments may have a static or dynamic topology. Network(s) 410 may include a secure network such as an enterprise network, an unsecure network, such as a wireless open network, or the Internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared and other wireless media.

Many other configurations of computing devices, applications, engines, and modules may be employed to mitigate a failure of an online meeting invitation. Furthermore, the networked environments discussed in FIG. 4 are for illustration purposes only. Embodiments are not limited to the example services, applications, engines, modules or processes.

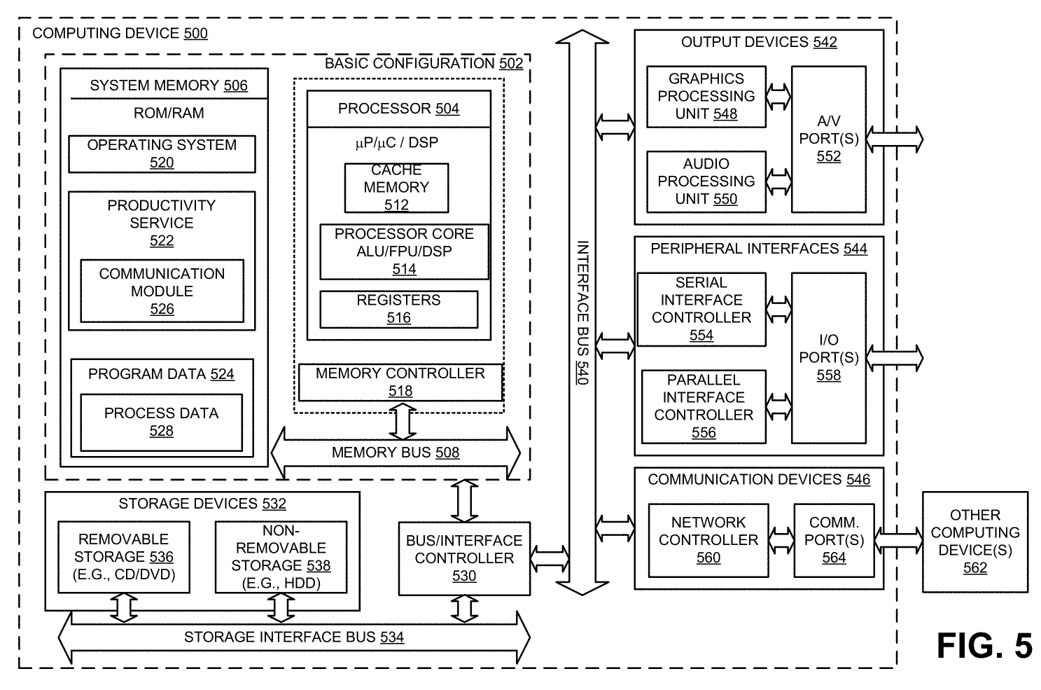

FIG. 5 illustrates a general purpose computing device, which may be configured to mitigate a failure of an online meeting invitation, arranged in accordance with at least some embodiments described herein.

For example, computing device 500 may be used as a server, desktop computer, portable computer, smart phone, special purpose computer, or similar device. In an example basic configuration 502, the computing device 500 may include one or more processors 504 and a system memory 506. A memory bus 508 may be used for communicating between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, one or more processor cores 514, and registers 516. The example processor cores 514 may (each) include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, a productivity service 522, and program data 524. The productivity service 522 may include a communication module 526, which may be an integrated module of the productivity service 522. In other embodiments, the communication module 526 may be an integrated module of a locally installed application of the productivity service 522 or the communication module 526 may be a separate module associated with a third party service configured to serve multiple applications of the productivity service 522. The communication module 526 may be configured to transmit a meeting invitation to an application associated with the productivity service 522 for presentation to an invitee. In response to receipt of a failure notification to reach the invitee, the communication module 526 may be configured to mitigate the failure by identifying an email address associated with the meeting invitation, generating an invitation email that includes the meeting invitation, and transmitting the invitation email to the email address for presentation to the invitee through a user experience of the application. Alternatively, the communication module 526 may be configured to forward just the meeting invitation to the email address upon identification. The program data 524 may include, among other data, process data 528 such as meeting data, as described herein.

The computing device 500 may have additional features or functionality, and additional interfaces to facilitate communications between the basic configuration 502 and any desired devices and interfaces. For example, a bus/interface controller 530 may be used to facilitate communications bet ween the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 505, the removable storage devices 536 and the non-removable storage devices 538 are examples of computer storage media. Computer storage media includes, but is not limited to, RAM, ROM EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interlaces 544, and one or more communication devices 546) to the basic configuration 502 via the bus/interface controller 530. Some of the example output devices 542 include a graphics processing unit 548 and an audio processing unit 550, which may be configured to communicate to various external devices such as a display or speakers via one or more A/V ports 552. One or more example peripheral interfaces 544 may include a serial interface controller 554 or a parallel interlace controller 556, which may be configured to communicate with external devices such as input devices (for example, keyboard, mouse, pen, voice input device, touch input device, etc.) or other peripheral devices (for example, printer, scanner, etc.) via one or more I/O ports 538. An example communication device 546 includes a network controller 560, which may be arranged to facilitate communications with one or more other computing devices 562 over a network communication link via one or more communication ports 564. The one or more other computing devices 562 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

Example embodiments may also include methods to mitigate a failure of an online meeting invitation. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

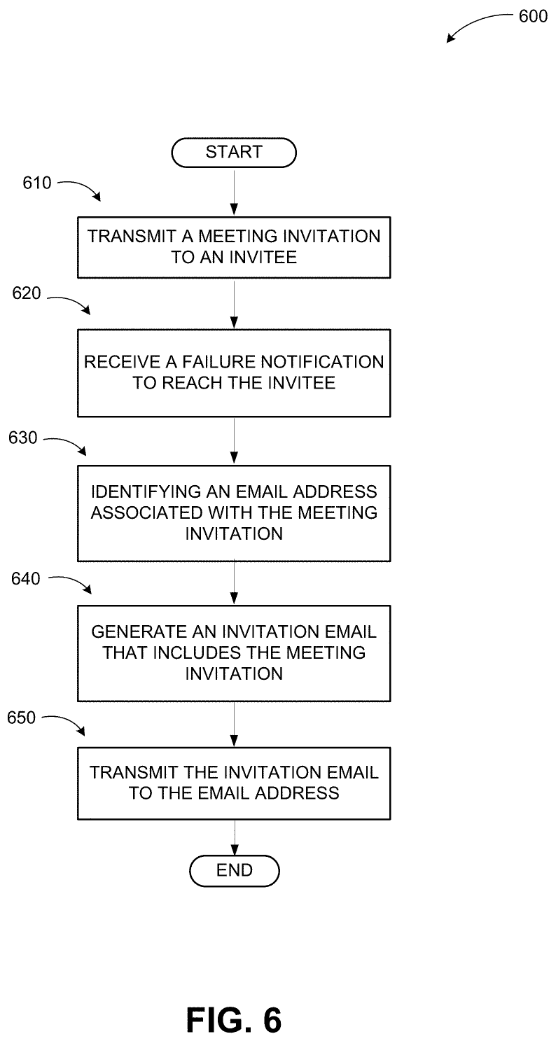

FIG. 6 illustrates a logic flow diagram for an example server-side process to mitigate a failure of an online meeting invitation, arranged in accordance with at least some embodiments described herein. Process 600 may be implemented on a computing device, server, or other system. An example system may include a communication interlace configured to facilitate communication between a productivity service and an application of the productivity service, a memory configured to store instructions, and one or more processors coupled to the memory and configured to execute a communication module, wherein the communication module is configured to mitigate a failure of an online meeting invitation.

Process 600 begins with operation 610, where the communication module may transmit a meeting invitation to an application associated with the productivity service for presentation to an invitee. The meeting invitation may be transmitted in response to detecting a selection by a meeting organizer or current invitee to add the invitee to a meeting through a user experience of the application.

At operation 620, the communication module may receive a failure-notification to reach the invitee. In one embodiment, the application may be configured to generate the failure notification, and provide the failure notification to the communication module. In another embodiment, the failure notification may be generated by a component of the productivity service upon a failure to receive a confirmation of the meeting invitation. In response to receipt of the failure notification to reach the invitee, the communication module may be configured to mitigate the failure by performing operations 630 through 650.

At operation 630, the communication module may identify an email address associated with the meeting invitation. The email address may be identified by first looking up the invitee to Whom the meeting invitation was transmitted in an address book by the SIP address. Or if that is unsuccessful, the email address may be identified by reinterpreting the SIP address as an email address. Alternatively, the communication module may identify the email address of the invitee provided when the meeting invitation was initially generated.

At operation 640, the communication module may generate an invitation email that includes the meeting invitation. At operation 650, the communication module may transmit the invitation email to the email address for presentation to the invitee through a user experience of the application. The invitation email may also include a notification that describes attempts to contact the invitee to deliver the meeting invitation and failures associated with the attempts, provides a history associated with the meeting invitation, and/or includes descriptive content with the meeting invitation that provides join links and/or other join features.

The operations included in process 600 are for illustration purposes. Mitigation of a failure of an online meeting invitation may be implemented by similar processes with fewer or additional steps, as well as in different order of operations using the principles described herein, The operations described herein may be executed by one or more processors operated on one or more computing devices, one or more processor cores, specialized processing devices, and/or general purpose processors, among other examples.

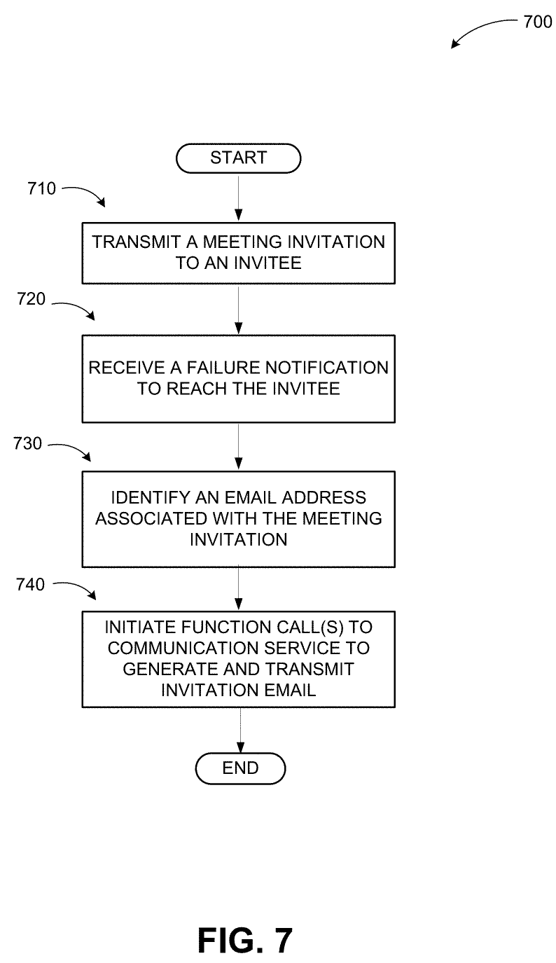

FIG 7 illustrates a logic flow diagram for an example client-side process to mitigate a failure of an online meeting invitation, arranged in accordance with at least some embodiments described herein. Process 700 may be implemented on a client device. An example client device may include a communication interface configured to facilitate communication between a productivity service and the client device, a memory configured to store instructions, and one or more processors coupled to the memory and configured to execute a communication module, wherein the communication module is configured to mitigate a failure of an online meeting invitation originating at the client device.

Process 700 begins with operation 710, where the communication module may transmit a meeting invitation for presentation to the invitee, where the meeting invitation originated via an application associated with the productivity service that is being executed on the client device.

At operation 720, the communication module may receive a failure notification to reach the invitee. The failure notification may be generated by and received from the application via which the meeting invitation originated. In response to receipt of the failure notification to reach the invitee, the communication module may be configured to mitigate the failure by performing operations 730 through 750.

At operation 730, the communication module may identify an email address associated with the meeting invitation. The email address may be identified by first looking up the invitee to whom the meeting invitation was transmitted in an address book associated with the application by the SIP-address. Or if that is unsuccessful, the email address may be identified by reinterpreting the SIP address as an email address. Alternatively, the communication module may use an email address of the invitee provided when the meeting invitation was initially generated.

At operation 740, the communication module may initiate one or more function calls through predefined APIs of an associated communication service to have an invitation email that includes the meeting invitation and optionally additional information generated and transmitted to the email address for presentation to the invitee. The invitation email may also include a notification that describes attempts to contact the invitee to deliver the meeting invitation and failures associated with the attempts, provides a history associated with the meeting invitation, and/or includes descriptive content with the meeting invitation that provides join links and/or other join features.

The operations included in process 700 are for illustration purposes. Mitigation of a failure of an online meeting invitation may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some embodiments, means to mitigate a failure of a meeting invitation may be described. Example means may include a means for transmitting a meeting invitation to an invitee, receiving a failure notification to reach the invitee, a means for identifying an email address associated with the meeting invitation, and a means for initiating one or more function calls to a communication service to have an invitation email generated and transmitted to the identified email address, where the invitation email includes the meeting invitation in a body of the invitation email.

According to some examples, methods to mitigate a failure of a meeting invitation may be described. An example method may include transmitting a meeting invitation to an invitee, receiving a failure notification to reach the invitee, identifying an email address associated with the meeting invitation, and initiating one or more function calls to a communication service to have an invitation email generated and transmitted to the identified email address, where the invitation email includes the meeting invitation in a body of the invitation email.

In other examples, an address book associated with the invitee may be used to identify the email address, an email address of the invitee provided by a meeting organizer may be used, or a SIP address may be re-interpreted as an email address. The meeting invitation may be automatically forwarded to the email address upon identification. The failure notification to reach the invitee may be received from an application associated with a productivity service through which the meeting invitation was generated, where the application may be executed on a client device. The failure notification to reach the invitee may be received from the productivity service, where the productivity service may generate the failure notification in response to detecting a failure to receive a confirmation of the meeting invitation at the productivity service.

In further examples, the attempt to mitigate the failure of the meeting invitation may be blocked in response to a determination that the invitee transmits a rejection of the meeting invitation. The invitation email may be generated to include a notification that describes attempts to contact the invitee to deliver the meeting invitation and one or more failures associated with the attempts. The invitation email may be generated to include a history associated with the meeting invitation. The invitation email may be generated to include descriptive content that provides one or more join features.

According to some embodiments, client devices to mitigate a failure of a meeting invitation may be described. An example client device comprises a communication interface configured to facilitate communication between a productivity service and the client device, a memory configured to store instructions, and one or more processors coupled to the memory and configured to execute a communication module. The communication module may be configured to transmit a meeting invitation to an invitee, receive a failure notification to reach the invitee, identify an email address associated with the meeting invitation, and initiate one or more function calls to a communication service to have an invitation email generated and transmitted to the identified email address, wherein the invitation email includes the meeting invitation in a body of the invitation email.

In other embodiments, the communication module may be configured to transmit the meeting invitation to the invitee in response to detecting a selection by a meeting organizer or current invitee to add the invitee to a meeting associated with the meeting invitation through one or more applications associated with the productivity service that is being executed on the client device. The applications may be configured to provide the selection to add the invitee to the meeting to the productivity service through the communication interface. The meeting invitation maybe automatically forwarded to the email address upon identification.

In further embodiments, the communication module may be an integral module of one or more applications of the productivity service being executed by the client device. The applications of the productivity service being executed by the client device include a communication application, a calendar application, a word-processing application, a notebook application, and a spreadsheet application.

According to some examples, methods to mitigate a failure of a meeting invitation may be provided. An example method may include transmitting a meeting invitation to an invitee, receiving a failure notification to reach the invitee, identifying an email address associated with the meeting invitation, initiating one or more function calls to a communication service to have an invitation email generated, and transmitted to the identified email address, where the invitation email includes the meeting invitation in a body of the invitation email, a notification that describes attempts to contact the invitee to deliver the meeting invitation and one or more failures associated with the attempts, a history associated with the meeting invitation, and descriptive content that provides one or more join features.

In other examples, the failure notification to reach the invitee may be received from an application associated with the productivity service through which the meeting invitation originated, where the application may be executed on a client device or the failure notification to reach the invitee may be received from the productivity service, where the productivity service may generate the failure notification in response to detecting a failure to receive a confirmation of the meeting invitation at the productivity service. An address book associated with the invitee may be used to identify the email address, an email address of the invitee provided by a meeting organizer may be used, or a SIP address may be re-interpreted as an email address.

The above specification, examples and data provide a complete description of the manufacture and use of the composition of the embodiments. Although the subject matter has been described in language specific to structural features and/or methodological acts, it is to be understood, that the subject matter defined in the appended claims is not necessarily limited to the specific features or acts described above. Rather, the specific features and acts described above are disclosed as example forms of implementing the claims and embodiments.

What is claimed is:

1. A method to mitigate a failure of a meeting invitation, the method comprising:
transmitting a meeting invitation to an invitee;
receiving a failure notification to reach the invitee;
identifying an email address associated with the meeting invitation; and
initiating one or more function calls to a communication service to have an invitation email generated and transmitted to the identified email address, wherein the invitation email includes the meeting invitation in a body of the invitation email.

2. The method of claim 1, wherein identifying the email address associated with the meeting invitation comprises:
instructing the communication service to search an address book associated with the invitee to identify the email address.

3. The method of claim 1, wherein identifying the email address associated with the meeting invitation comprises:
using an email address of the invitee provided by a meeting organizer.

4. The method of claim 1, wherein identifying the email address associated with the meeting invitation comprises:
re-interpreting a Session Initiation Protocol (SIP) address as an email address.

5. The method, of claim 1, further comprising:
transmitting the meeting invitation to the invitee using SIP.

6. The method of claim 1, wherein receiving the failure notification to reach the invitee comprises:
receiving the failure notification to reach the invitee from an application associated with a productivity service through which the meeting invitation was generated, wherein the application is executed on a client device.

7. The method of claim 6, wherein receiving the failure notification to reach the invitee comprises:
receiving the failure notification to reach the invitee from the productivity service, wherein the productivity service generates the failure notification in response to detecting a failure to receive a confirmation of the meeting invitation, at the productivity service.

8. The method of claim 1, further comprising:
in response to a determination that the invitee transmits a rejection of the meeting invitation, blocking the attempt to mitigate the failure of the meeting invitation.

9. The method of claim 1, further comprising:
instructing the communication service to generate the invitation email to include a notification that describes attempts to contact the invitee to deliver the meeting invitation and one or more failures associated with the attempts.

10. The method of claim 1, further comprising:
instructing the communication service to generate tile invitation email to include a history associated with the meeting invitation.

11. The method of claim 1, further comprising;
instructing the communication service to generate the invitation email to include descriptive content that provides one or more join features.

12. A computing device to mitigate a failure of a meeting invitation, the computing device comprising:
a communication interface configured to facilitate communication between a productivity service and the computing device;
a memory configured to store instructions; and
one or more processors coupled to the memory and configured to execute a communication module, wherein the communication module is configured to:
transmit a meeting invitation to an invitee;
receive a failure notification to reach the invitee;
identity an email address associated with the meeting invitation; and
initiate one or more function calls to a communication service to have an invitation email generated and transmitted to the identified email address, wherein the invitation email includes the meeting invitation in a body of the invitation email.

13. The computing device of claim 12, wherein the communication module is configured to transmit the meeting invitation to the invitee in response to detecting a selection by a meeting organizer or current invitee to add the invitee to a meeting associated with the meeting invitation through one or more applications associated with the productivity service that is being executed on the computing device.

14. The computing device of claim 13, wherein the one or more applications are configured to provide the selection to add the invitee to the meeting to the productivity service through the communication interface.

15. The computing device of claim 12, wherein the meeting invitation is automatically forwarded to the email address upon identification.

16. The computing device of claim 12, wherein the communication module is an integral module of one or more applications of the productivity service being executed by the computing device.

17. The computing device of claim 16, wherein the one or more applications of the productivity service being executed by the client device include a communication application, a calendar application, a word-processing application, a notebook application, and a spreadsheet application.

18. A method to mitigate a failure of a meeting invitation, the method comprising:
transmitting a meeting invitation to an invitee;
receiving a failure notification to reach the invitee;
identifying an email address associated with the meeting invitation; and
initiating one or more function calls to a communication service to have an invitation email generated and transmitted to the identified email address, wherein the invitation email includes the meeting invitation in a body of the email, a notification that describes attempts to contact the invitee to deliver the meeting invitation and one or more failures associated with the attempts, a history associated with the meeting invitation, and descriptive content that provides one or more join features.

19. The method of claim 18, wherein receiving the failure notification to reach the invitee comprises one of:
receiving the failure notification to reach the invitee from an application associated with the productivity service through which the meeting invitation originated, wherein the application is executed on a client device; and
receiving the failure notification to reach the invitee from the productivity service, wherein the productivity service generates the failure notification in response to detecting a failure to receive a confirmation of the meeting invitation at the productivity service.

20. The method of claim 1, wherein identifying the email address associated with the meeting invitation comprises one or more of:
instructing the communication service to search an address book associated with the invitee to identify the email address;
using an email address of the invitee provided by a meeting organizer; and
re-interpreting a Session initiation Protocol (SIP) address as an email address.
